(19) United States
(12) Patent Application Publication
(10) Pub. No.: US 2025/0297936 A1
(43) Pub. Date: Sep. 25, 2025

(54) Adhesion Amount Measurement System

(71) Applicant: Nippon Telegraph and Telephone Corporation, Tokyo (JP)

(72) Inventor: Takuya Otsuka, Musashino-shi, Tokyo (JP)

(21) Appl. No.: 18/863,269

(22) PCT Filed: May 13, 2022
(86) PCT No.: PCT/JP2022/020225

§ 371 Date: Nov. 5, 2024

(51) Int. Cl. G01N 13/00; G06T 7/20

(52) U.S. Cl. CPC G01N 13/00; G06T 7/20; G06T 2207/10016; G06T 2207/10048

(57) ABSTRACT

An adhesion liquid amount measurement system includes: a measurement device that images a test object disposed in a test object observation area from a plurality of directions and measures and records a distribution of an adhesion liquid amount which is adhered to a surface of the test object at predetermined time intervals by near-infrared spectroscopy; an imaging device that images a fine particle tracking area adjacent to the test object observation area and tracks and records liquid fine particles in the fine particle tracking area; a spray device that sprays liquid fine particles to the test object observation area and the fine particle tracking area; and an estimation device that estimates and calculates a temporal change of a distribution of an adhesion liquid amount to be adhered to a surface of a structure installed in an installation scheduled area by using time-series image data.

### TECHNICAL FIELD

The present invention relates to an adhesion liquid amount measurement system that measures a distribution of an adhesion liquid amount to be adhered to a structure. In particular, the present invention relates to a technique of utilizing, for designing of a new structure, a moisture amount estimation method using a near infrared (NIR) region spectrum camera.

### BACKGROUND ART

In the near-infrared region, absorption spectra of molecules containing elements of hydrogen, carbon, nitrogen, oxygen, sulfur, and the like are distributed, and absorption bands of water molecules are present near a region of 1450 nm and a region of 1950 nm. For this reason, Non Patent Literature 1 discloses a technique of performing NIR spectrum measurement of rice confectionery using an NIR image measurement device including an NIR spectrum camera, and estimating and calculating an adhesion moisture amount of the rice confectionery from the measured NIR spectrum image by using a moisture amount estimation device.

### CITATION LIST

### Non Patent Literature

Non Patent Literature 1: Maiko TAKEYAMA and six others, “Measurement of the Water Content and the Moisture Vaporization Enthalpy in Rice Cracker with Portable Near Infrared Spectrometer”, The Japan Society for Analytical Chemistry, BUNSEKI KAGAKU, Vol. 60, No. 1, 2011, p.33-p.38

### SUMMARY OF INVENTION

### Technical Problem

However, in a case where there is a specific circumstance in an installation scheduled place of an estimation target, such as outdoor or semi-outdoor, a temporal change of an adhesion moisture amount to be adhered to the estimation target cannot be appropriately estimated by a method using only the NIR image measurement device or the moisture amount estimation device. This is because outdoor high-rise buildings, bridges, semi-outdoor equipment, and the like are subject to corrosion and deterioration due to wind and rain and trace substances in the atmosphere.

Therefore, in a structure installed in an installation scheduled area, a technique capable of appropriately estimating a temporal change of a distribution of an adhesion moisture amount to be adhered to a surface of the structure is desired. In particular, corrosion of metal materials progresses by repeated wetting due to moisture and drying due to sunlight or wind, and thus means for appropriately examining shape design when designing a metallic structure is required.

The present invention has been made in view of the above circumstances, and an object of the present invention is to provide a technique capable of appropriately estimating a temporal change of a distribution of an adhesion liquid amount to be adhered to a surface of a new structure designed by a computer or the like.

### Solution to Problem

According to an aspect of the present invention, there is provided an adhesion liquid amount measurement system including: a measurement device that images a test object disposed in a test object observation area from a plurality of directions and measures and records a distribution of an adhesion liquid amount which is adhered to a surface of the test object at predetermined time intervals by near-infrared spectroscopy; an imaging device that images a fine particle tracking area adjacent to the test object observation area and tracks and records liquid fine particles in the fine particle tracking area; a spray device that sprays liquid fine particles to the test object observation area and the fine particle tracking area; and an estimation device that estimates and calculates a temporal change of a distribution of an adhesion liquid amount to be adhered to a surface of a structure installed in an installation scheduled area by using time-series image data recorded by the measurement device and time-series image data recorded by the imaging device.

### Advantageous Effects of Invention

According to the present invention, it is possible to provide a technique capable of appropriately estimating a temporal change of a distribution of an adhesion liquid amount to be adhered to a surface of a new structure designed by a computer or the like.

### BRIEF DESCRIPTION OF DRAWINGS

FIG. 1 is a diagram illustrating a specific example and an installation example of a structure.

FIG. 2 is a diagram illustrating a device configuration example of an adhesion moisture amount measurement system.

FIG. 3 is a diagram illustrating a construction example and a configuration example of a surface moisture amount time-series estimation machine.

FIG. 4 is a diagram illustrating a flow for estimating a temporal change of a distribution of an adhesion moisture amount of a surface of a structure.

FIG. 5 is a diagram illustrating an estimation example of a temporal change of a distribution of an adhesion moisture amount of a surface of a structure.

FIG. 6 is a diagram illustrating a hardware configuration example of a surface moisture amount time-series estimation machine.

### DESCRIPTION OF EMBODIMENTS

Hereinafter, an embodiment of the present invention will be described with reference to the drawings. In the drawings, the same parts are denoted by the same reference numerals, and description thereof is omitted.

### Summary of Invention

The present invention relates to a method for estimating a temporal change of a distribution of an adhesion liquid amount to be adhered to a surface of a novel structure designed by a computer or the like, and a method for acquiring data required for implementing the estimation method.

The present invention is characterized in that a fine particle tracer imaging device that tracks and records liquid fine particles in an adjacent area which is adjacent to an installation scheduled area of a structure and a spray processing device that sprays the liquid fine particles are further used, instead of using only an NIR image measurement device and a moisture amount estimation device as in the case in the related art. That is, the present invention utilizes time-series image data of liquid fine particles recorded by the fine particle tracer imaging device, in addition to time-series image data of an adhesion liquid amount recorded by the NIR image measurement device.

In the time-series image data recorded by the fine particle tracer imaging device, a movement state of the liquid fine particle that changes from moment to moment until the liquid fine particle reaches the structure is recorded. Thus, it is possible to appropriately estimate a temporal change of a distribution of an adhesion liquid amount to be adhered to a surface of the structure. As a result, an adhesion moisture amount of the surface of the structure can be appropriately estimated by a computer before the structure is created. Thereby, shape design and material selection of the structure that is resistant to corrosion are facilitated.

### Specific Example and Installation Example of Structure

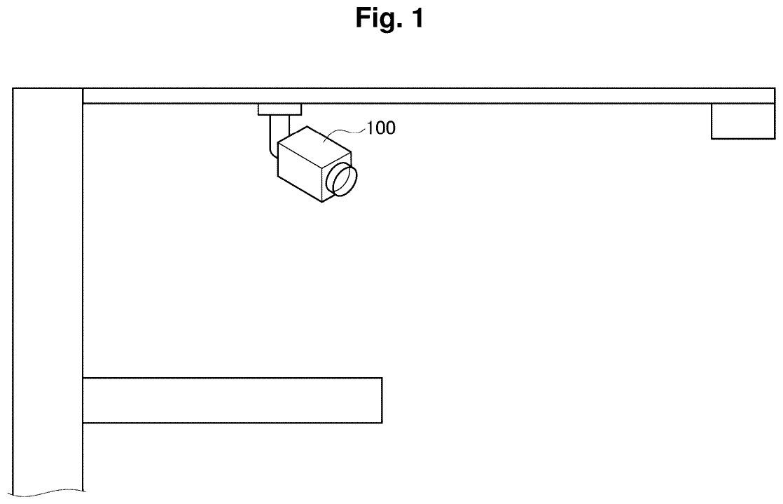

FIG. 1 is a diagram illustrating a specific example and an installation example of a structure 100 to be designed. The structure 100 is a structure (for example, a monitoring camera or the like) newly designed for a computer, and is installed outdoors or semi-outdoors (for example, a building, a bridge, or the like). In order to contribute to a search for an optimum shape and an optimum material of a structure that is resistant to corrosion, the present invention estimates a temporal change of a distribution of an adhesion liquid amount to be adhered to a surface of the structure 100.

### Device Configuration Example of Adhesion Moisture Amount Measurement System

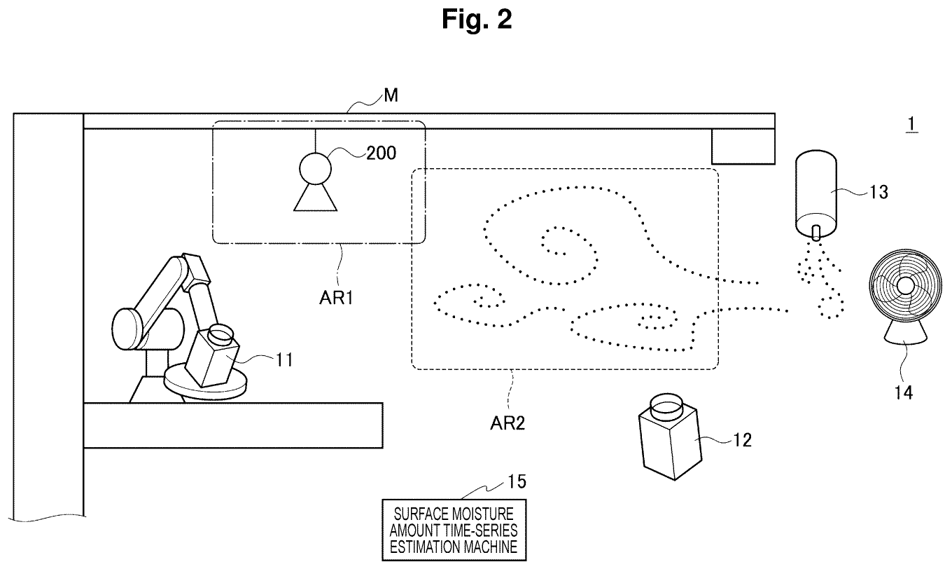

FIG. 2 is a diagram illustrating a device configuration example of an adhesion moisture amount measurement system 1. Note that the adhesion moisture amount measurement system 1 is an example of an adhesion liquid amount measurement system. Water is an example of an adhesion object, and the system can be applied to any liquid.

The adhesion moisture amount measurement system 1 includes, for example, an NIR image measurement device 11, a fine particle tracer imaging device 12, a spray processing device 13, an electric fan 14, and a surface moisture amount time-series estimation machine 15. AR1 in FIG. 2 is a test object observation area in which a test object 200 corresponding to the structure 100 is disposed and a surface of the test object 200 is imaged from a plurality of directions. AR2 is a fine particle tracking area adjacent to the test object observation area AR1.

The NIR image measurement device 11 is a measurement device that includes an NIR spectrum camera and measures a temporal change of a distribution of an adhesion moisture amount due to water adhesion or water evaporation after spray processing is performed on the test object 200. For example, the NIR image measurement device 11 is provided at a distal end of a robot arm, images the surface of the test object 200 disposed in the test object observation area AR1 from a plurality of directions, and measures and records time-series image data of a distribution of an adhesion moisture amount adhered to the surface of the test object 200 at predetermined time intervals by a near-infrared spectroscopic function included in the device.

The fine particle tracer imaging device 12 is an imaging device that images the fine particle tracking area AR2 adjacent to the test object observation area ARI, and tracks and records movement of water particles floating and scattering in a space of the fine particle tracking area AR2 during the spray processing. For example, the fine particle tracer imaging device 12 tracks and records time-series image data of the water particles in the fine particle tracking area AR2 at predetermined time intervals.

The spray processing device 13 is a spray device that operates in cooperation with the NIR image measurement device 11 and the fine particle tracer imaging device 12, and sprays the water particles to the test object 200 in the test object observation area AR1 by spraying the water particles to the test object observation area AR1 and the fine particle tracking area AR2.

The electric fan 14 is an auxiliary tool that operates in cooperation with the spray processing device 13 and is for causing the water particles to reach the test object 200. The electric fan 14 controls a blowing amount of the water particles to be sprayed to the test object observation area AR1.

The surface moisture amount time-series estimation machine 15 is an estimation device that is communicably connected to the NIR image measurement device 11, the fine particle tracer imaging device 12, the spray processing device 13, and the electric fan 14, and estimates and calculates a temporal change of a distribution of an adhesion moisture amount to be adhered to a surface of the structure 100 (refer to FIG. 1) installed in an installation scheduled area (≈test object observation area AR1) by using the time-series image data recorded by each of the NIR image measurement device 11 and the fine particle tracer imaging device 12.

Specifically, the surface moisture amount time-series estimation machine 15 learns the temporal change of the distribution of the adhesion moisture amount to be adhered to the surface of the test object 200 by using the shape data of the test object 200 in the test object observation area AR1, the time-series image data of the distribution of the adhesion moisture amount adhered to the surface of the test object 200, and the time-series image data of the water particles in the fine particle tracking area AR2.

In addition, the surface moisture amount time-series estimation machine 15 estimates and calculates the temporal change of the distribution of the adhesion moisture amount to be adhered to the surface of the structure 100 by using the shape data of the structure installed in the installation scheduled area, the time-series image data of the water particles in the fine particle tracking area adjacent to the installation scheduled area, and the learning result of the temporal change of the distribution of the adhesion moisture amount.

### Outline of Operation of Adhesion Moisture Amount Measurement System

A user of the adhesion moisture amount measurement system 1 prepares a plurality of types of shapes of basic elements of the test object 200.

Next, the adhesion moisture amount measurement system 1 performs spray processing on the test object observation area AR1 and the fine particle tracking area AR2 a plurality of times. In addition, the adhesion moisture amount measurement system 1 acquires video data of the sprayed water particles, and further acquires video data obtained by measuring the adhesion moisture amount adhered to the surface of the test object 200 with the NIR spectrum camera.

Thereafter, the adhesion moisture amount measurement system 1 constructs a surface moisture amount time-series estimation machine 15 for estimating a temporal change of a distribution of an adhesion moisture amount to be adhered to the surface of the test object 200 having an arbitrary shape by using the acquired two types of video data. In addition, the adhesion moisture amount measurement system 1 acquires an estimation value of the temporal change of the distribution of the adhesion moisture amount to be adhered to the surface of the structure 100 of which the shape is newly designed by the constructed surface moisture amount time-series estimation machine 15.

Thereby, before the structure 100 is actually created, it is possible to acquire the estimation value of the temporal change of the distribution of the adhesion moisture amount in the installation scheduled area of the structure 100, and thus the shape design of the structure resistant to corrosion is facilitated.

### Example

### Configuration of Measurement System Moisture Amount to Be Adhered to Surface and Acquisition of Surface Moisture Amount Data

First, there is prepared the adhesion moisture amount measurement system 1 that measures a moisture amount to be adhered to each portion of the surface of the test object 200 and a temporal change of the moisture amount by using a stand M on which the test object 200 is disposed and the spray processing device 13 that sprays water to the test object 200.

As illustrated in FIG. 2, the adhesion moisture amount measurement system 1 includes an NIR image measurement device 11 that images the test object 200 disposed on the stand M by the NIR spectrum camera from a plurality of directions, and a fine particle tracer imaging device 12 that generates video data of water particles floating and scattering in the fine particle tracking area AR2.

The test object 200 having a predetermined basic element shape is disposed on a stand M, and spray processing is performed a plurality of times according to a spray processing condition pattern in which a spray amount, a spray time, a spray angle, and the like, which are spray processing conditions, are adjusted and changed. At a time of execution of each of pieces of spray processing, video data of the fine particle tracking area AR2 is measured by the fine particle tracer imaging device 12. In addition, the moisture amount adhered to the surface of the test object 200 is measured at predetermined time intervals by the NIR image measurement device 11 every time each of pieces of spray processing is completed.

For example, the NIR image measurement device 11 acquires time-series image data of a two-dimensional image of the adhesion moisture amount of the surface of the test object 200 by imaging the test object 200 from a fixed position with the NIR spectrum camera having a near-infrared spectroscopic function. Alternatively, the NIR image measurement device 11 acquires time-series image data of a three-dimensional image with an NIR spectrum camera having a movable mechanism.

For example, the fine particle tracer imaging device 12 acquires time-series image data of a two-dimensional image in which a scattering situation of water particles is imaged, by using a laser sheet by particle image velocimetry (PIV)) at a fixed position. Alternatively, the fine particle tracer imaging device 12 acquires time-series image data of a three-dimensional image by performing time-division scanning of the observation space with a plurality of laser sheets.

According to the processing procedure, a plurality of sets of each of pieces of the time-series image data of the movement of the water particles to the test object 200 and each of pieces of the video data of the distribution of the adhesion moisture amount of the surface of the test object 200 are acquired for one basic element shape of the test object 200.

In addition, a plurality of types of test objects 200 in which the shape of the basic element is changed are prepared, and the processing procedure is also performed for each of the test objects. Thereby, a plurality of sets of each of pieces of the time-series image data of the movement of the water particles to the test object 200 and each of pieces of the video data of the distribution of the adhesion moisture amount of the surface of the test object 200 are acquired for a plurality of test objects 200 with different shapes.

Note that the shape of the basic element of the test object 200 is desirably a shape in which a partial structure or a partial shape of the structure 100 to be designed is reflected.

### Construction Example/Configuration Example of Surface Moisture Amount Time-Series Estimation Machine

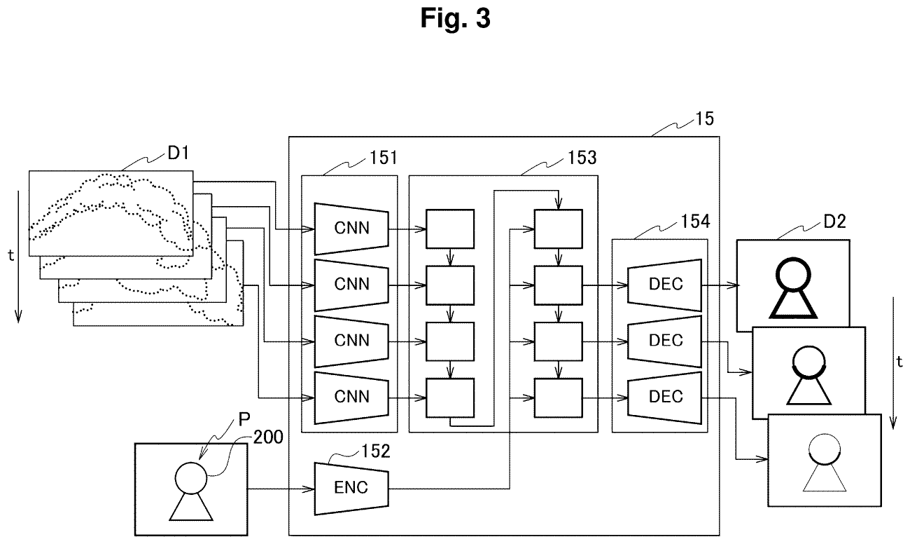

FIG. 3 is a diagram illustrating a construction example and a configuration example of the surface moisture amount time-series estimation machine 15.

The surface moisture amount time-series estimation machine 15 that estimates and calculates the video data D2 of the distribution of the adhesion moisture amount adhered to the surface of the test object 200 by using, as inputs, the shape pattern P of the basic element and the video data D1 of the movement of the water particles for a plurality of test objects 200 having shapes different from each other, based on the shape pattern P of the basic element included in the test object 200, the video data D1 of the movement of the water particles in the fine particle tracking area AR2 for the shape pattern P, and the video data D2 of the distribution of the adhesion moisture amount adhered to the surface of the test object 200, is constructed.

For example, the surface moisture amount time-series estimation machine 15 includes a plurality of first encoding layers 151 that respectively extract image features of the water particles from each of pieces of time-series image data of the video data D1, and a second encoding layer 152 that extracts a shape feature of the shape pattern P of the basic element included in the test object 200. The first encoding layer 151 is a feature extractor such as a convolutional neural network (CNN).

The surface moisture amount time-series estimation machine 15 inputs time-series image features of each of the water particles extracted in each of the first encoding layers 151 to an estimation unit 153 which is a series of estimation layers. The estimation unit 153 is, for example, a long short term memory (LSTM) or a gated recurrent unit (GRU).

The surface moisture amount time-series estimation machine 15 inputs, to the estimation unit 153, the shape feature of the shape pattern P of the basic element extracted in the second encoding layer 152, and inputs, to each decoding layer 154, the video data D2 together with the image features of the water particles of the video data D1 extracted in the first encoding layer 151.

Specifically, an auto encoder #1 in which the shape pattern P of the basic element included in the test object 200 is set as input/output and an auto encoder #2 in which the video data D2 is set as input/output are trained in advance.

In addition, an encoder/decoder in which an encoding layer of the auto encoder #1 and a decoding layer of the auto encoder #2 are connected is trained in advance such that the encoder/decoder outputs, for the shape pattern P of the basic element, an average image (for example, a time average image by imaging during an observation period of several minutes to several hours) of the video data D2 corresponding to the shape pattern P.

In addition, encoding and decoding of the encoder/decoder are respectively set as the second encoding layer 152 and the decoding layer 154, variable parameters of encoding and decoding when the average image is output are set as initial values of variable parameters of the layers 152 and 154, and learning is repeated. Thereby, the estimation unit 153 that can estimate and calculate the time-series data of the distribution of the adhesion moisture amount to be adhered to the surface of the test object 200 is constructed.

That is, the encoder/decoder is trained in advance using the average image, and parameters used in the training are set as initial values. In addition, each of decoding layers 154 that are independently constructed further repeatedly performs training of parameters for image sequence estimation, which is an original purpose. Finally, each of the decoding layers 154 converges to a network with individual parameters, and thus time-series image data is generated.

### Estimation of Distribution of Adhesion Moisture Amount

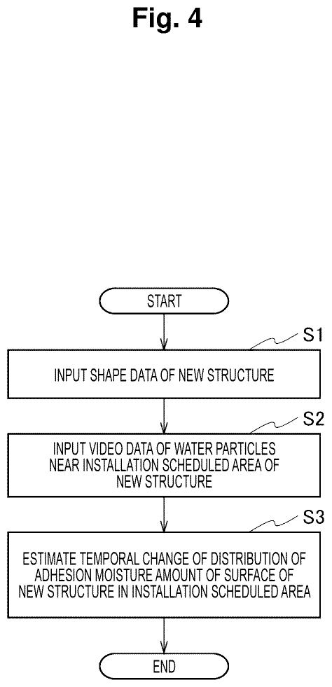

FIG. 4 is a diagram illustrating a flow for estimating the temporal change of the distribution of the adhesion moisture amount of the surface of the newly designed structure 100.

### Step S1

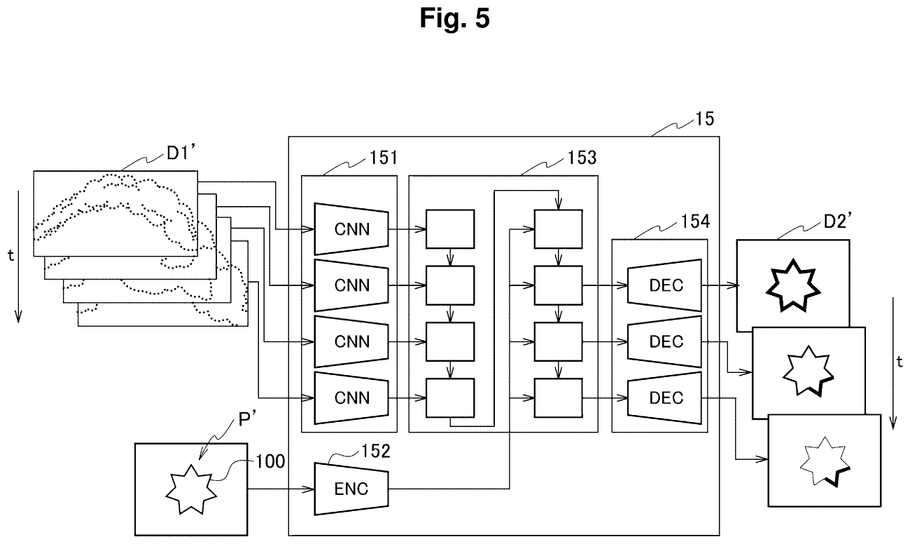

The surface moisture amount time-series estimation machine 15 inputs shape data of the shape pattern P′ of the newly designed structure 100 (refer to FIG. 5).

### Step S2

Next, in the installation scheduled area where the structure 100 is to be installed, water particles are scattered from the spray processing device 13. The surface moisture amount time-series estimation machine 15 acquires, from the fine particle tracer imaging device 12, video data D1′ of the water particles floating and scattering in the fine particle tracking area adjacent to the installation scheduled area (refer to FIG. 5).

### Step S3

Finally, the surface moisture amount time-series estimation machine 15 estimates and calculates the video data D2′ of the distribution of the adhesion moisture amount to be adhered to the surface of the structure 100 by using the shape data of the shape pattern P′ of the structure 100, the video data D1′ of the water particles in the fine particle tracking area, and the training result of the temporal change of the distribution of the adhesion moisture amount, the training result obtained by training so far (refer to FIG. 5).

The user repeatedly changes the design of the structure 100 such that a temporal transition of the moisture amount that is indicated by the video data D2′ falls within a predetermined use condition of the structure 100.

### Effects

According to the present embodiment, the adhesion moisture amount measurement system 1 includes: the NIR image measurement device 11 that images the test object 200 disposed in the test object observation area AR1 from a plurality of directions and measures and records a distribution of the adhesion moisture amount to be adhered to the surface of the test object 300 at predetermined time intervals by near-infrared spectroscopy; the fine particle tracer imaging device 12 that images the fine particle tracking area AR2 adjacent to the test object observation area ARI and tracks and records water particles in the fine particle tracking area AR2; the spray processing device 13 that sprays the water particles to the test object observation area AR1 and the fine particle tracking area AR2; and the surface moisture amount time-series estimation machine 15 that estimates and calculates a temporal change of a distribution of the adhesion moisture amount to be adhered to the surface of the structure 100 installed in an installation scheduled area by using time-series image data recorded by the NIR image measurement device 11 and time-series image data recorded by the fine particle tracer imaging device 12. Thereby, it is possible to provide a technique capable of appropriately estimating the temporal change of the distribution of the adhesion liquid amount to be adhered to the surface of the structure that is a newly designed by a computer or the like.

### Others

The present invention is not limited to the above embodiment. The present invention may be modified in various manners within the gist of the present invention.

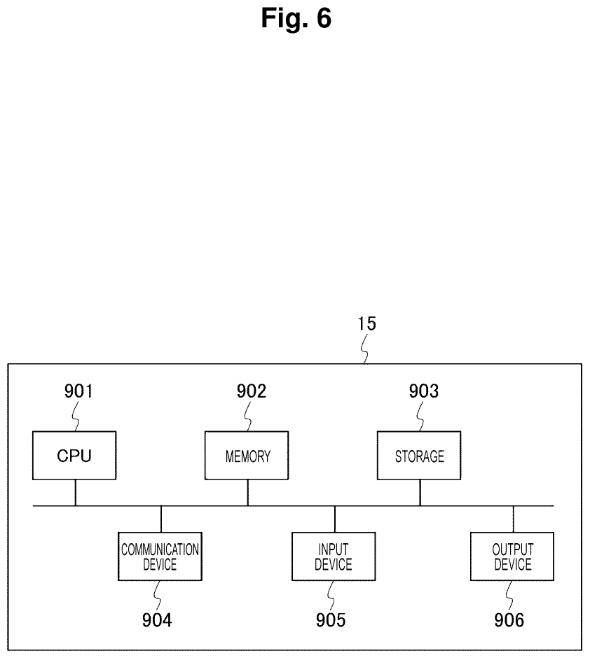

The surface moisture amount time-series estimation machine 15 of the present embodiment described above can be achieved by using, for example, a general-purpose computer system including a CPU 901, a memory 902, a storage 903, a communication device 904, an input device 905, and an output device 906 as illustrated in FIG. 6. The memory 902 and the storage 903 are storage devices. In the computer system, each function of the surface moisture amount time-series estimation machine 15 is implemented by the CPU 901 executing a predetermined program loaded on the memory 902.

The surface moisture amount time-series estimation machine 15 may be implemented by one computer. The surface moisture amount time-series estimation machine 15 may be implemented by a plurality of computers. The surface moisture amount time-series estimation machine 15 may be a virtual machine implemented in a computer. The program for the surface moisture amount time-series estimation machine 15 can be stored in a computer-readable recording medium such as an HDD, an SSD, a USB memory, a CD, or a DVD. The program for the surface moisture amount time-series estimation machine 15 can also be distributed via a communication network.

### Reference Signs List

1 Adhesion moisture amount measurement system
11 NIR image measurement device
12 Fine particle tracer imaging device
13 Spray processing device
14 Electric fan
15 Surface moisture amount time-series estimation machine
151 First encoding layer
152 Second encoding layer
153 Estimation unit
154 Decoding layer
100 Structure
200 Test object
901 CPU
902 Memory
903 Storage
904 Communication device
905 Input device
906 Output device

1. An adhesion liquid amount measurement system comprising:
a measurement device that images a test object disposed in a test object observation area from a plurality of directions and measures and records a distribution of an adhesion liquid amount which is adhered to a surface of the test object at predetermined time intervals by near-infrared spectroscopy;
an imaging device that images a fine particle tracking area adjacent to the test object observation area and tracks and records liquid fine particles in the fine particle tracking area;
a spray device that sprays liquid fine particles to the test object observation area and the fine particle tracking area; and
an estimation device that estimates and calculates a temporal change of a distribution of an adhesion liquid amount to be adhered to a surface of a structure installed in an installation scheduled area by using time-series image data recorded by the measurement device and time-series image data recorded by the imaging device.

2. The adhesion liquid amount measurement system according to claim 1,
wherein the estimation device learns a temporal change of a distribution of an adhesion liquid amount to be adhered to the surface of the test object by using shape data of the test object, time-series image data of the distribution of the adhesion liquid amount which is adhered to the surface of the test object, and time-series image data of the liquid fine particles in the fine particle tracking area.

3. The adhesion liquid amount measurement system according to claim 2,
wherein the estimation device estimates and calculates a temporal change of a distribution of an adhesion liquid amount to be adhered to a surface of the structure by using shape data of the structure, time-series image data of the liquid fine particles in the fine particle tracking area adjacent to the installation scheduled area, and a learning result of the temporal change of the distribution of the adhesion liquid amount.

4. The adhesion liquid amount measurement system according to claim 1,
wherein the liquid is water.

5. The adhesion liquid amount measurement system according to claim 2, wherein the liquid is water.

6. The adhesion liquid amount measurement system according to claim 3, wherein the liquid is water.
